(19) United States
(12) Patent Application Publication
(10) Pub. No.: US 2023/0237890 A1
(43) Pub. Date: Jul. 27, 2023

(54) INTRUDER LOCATION-BASED DYNAMIC VIRTUAL FENCE CONFIGURATION AND MULTIPLE IMAGE SENSOR DEVICE OPERATION METHOD

(71) Applicants: ELECTRONICS AND TELECOMMUNICATIONS RESEARCH INSTITUTE, Daejeon (KR); ESSETEL. CO., LTD., Daejeon (KR)

(72) Inventors: Young-il KIM, Sejong-si (KR); Seong Hee PARK, Daejeon (KR); Geon Min YEO, Daejeon (KR); Wun-Cheol JEONG, Daejeon (KR); Tae-Wook HEO, Sejong-si (KR); Sung Eun JIN, Seogwipo-si (KR)

(21) Appl. No.: 18/098,808

(22) Filed: Jan. 19, 2023

(30) Foreign Application Priority Data
Jan. 26, 2022 (KR) 10-2022-0011722
Dec. 28, 2022 (KR) 10-2022-0187272

(51) Int. Cl. G08B 13/196

(52) U.S. Cl. CPC G08B 13/19645; G08B 13/19608; G08B 13/1963

(57) ABSTRACT

An intruder location-based dynamic virtual fence configuration and a multiple image sensor device operation method are provided. A method of detecting an intruder based on a virtual fence includes detecting an intruder invading a virtual fence set in a protection area by using a first image sensor device, and tracking the intruder through cooperation with second image sensor devices adjacent to the first image sensor device, based on information of the intruder.

### CROSS-REFERENCE TO RELATED APPLICATIONS

This application claims the benefit of Korean Patent Application No. 10-2022-0011722 filed on Jan. 26, 2022, and Korean Patent Application No. 10-2022-0187272 filed on Dec. 28, 2022, in the Korean Intellectual Property Office, the entire disclosure of which is incorporated herein by reference for all purposes.

### BACKGROUND

### 1. Field of the Invention

The following description relates to an intruder location-based dynamic virtual fence configuration and a multiple image sensor device operation method.

### 2. Description of Related Art

To protect an important facility or an industrial facility of a country from an external intruder, it is necessary to set a virtual surveillance line for defending a protected facility, detect and track an intruder who crosses the virtual surveillance line, and implement a response strategy. To monitor the external intruder, a camera equipped with a magnification lens and an image sensor configured in an image processing device are commonly used. However, due to optical characteristics of the camera, a surveillance area is limitedly set depending on the magnification lens and the characteristics of the image sensor, and thus, there is a demand for setting and operating the surveillance area by efficiently using them.

The above description is information the inventor(s) acquired during the course of conceiving the present disclosure, or already possessed at the time, and is not necessarily art publicly known before the present application was filed.

### SUMMARY

To protect an important facility from an external intruder, there is a demand for installing a virtual fence on the boundary of the facility and building a system that detects an intruder crossing the virtual fence with an image sensor by an image deep learning technique and continuously tracks the intruder. In this case, to detect the intruder, the magnification of a camera zoom lens may need to be adjusted such that an image of the intruder has a pixel that is greater than or equal to a predetermined size and an observation direction of a camera may need to be controlled (e.g., a panning tilting (PT) control). Since the direction of the camera and the magnification of the lens need to be adjusted based on a movement path of the detected intruder, there is a demand for a technique for overcoming a dead zone of observation which occurs as an initially set observation range of the camera changes.

An example embodiment provides a method of installing a virtual fence based on a plurality image sensors to protect human and physical assets and dynamically configuring and operating the virtual fence based on cooperation between adjacent image sensor devices or by using a spare image sensor device to overcome a surveillance dead zone (or an observation dead zone) for an invading object (e.g., an intruder), where the dead zone occurs due to a change in an observation range of a camera when detecting an invading object and continuously tracking the invading object.

An example embodiment provides a method of dynamically configuring and operating a virtual surveillance line (e.g., a virtual fence) through cooperation of a plurality of image sensor devices by analyzing a movement characteristic of an invading object (e.g., an intruder) that invades a surveillance area.

By setting a virtual fence in an image sensor device, an example embodiment may not omit monitoring of an intruder by dynamically setting the virtual fence based on a movement path of an intruder.

An example embodiment may track multiple intruders by reducing deep learning inference time by dividing deep learning engines for detecting an intruder and tracking the intruder.

An example embodiment may track and manage multiple intruders by setting a unique identifier by location information of an intruder that appears in a protection area for the first time to distinguish multiple intruders and continuously managing the location information of the intruder by data attributes.

However, the technical aspects are not limited to the aforementioned aspects, and other technical aspects may be present.

According to an aspect, there is provided a method of detecting an intruder based on a virtual fence, the method including detecting an intruder invading a virtual fence set in a protection area by using a first image sensor device, and tracking the intruder through cooperation with second image sensor devices adjacent to the first image sensor device, based on information of the intruder.

The method further includes dynamically setting the virtual fence through cooperation with the second image sensor devices by controlling pan-tilt-zoom of the first image sensor device.

The method further includes setting initial location information at which the intruder is detected by the first image sensor device to be an identifier to distinguish the intruder.

The tracking includes, when the intruder escapes an observation range of the first image sensor device, selecting an image sensor device to track the intruder from among the second image sensor devices based on information of the intruder, and assigning a task to track the intruder to a selected image sensor device.

The tracking further includes calculating a neighborhood takeover region, which is a dead zone of the first image sensor device and occurs as the first image sensor device tracks the intruder.

The neighborhood takeover region corresponds to a difference between an initial observation range of the first image sensor device and an updated observation range, which is updated based on tracking the intruder, of the first image sensor device.

The tracking further includes setting a range in which cooperation among the first image sensor device and the second image sensor devices is available based on a time taken for the intruder to escape from an observation range of the first image sensor device and a time taken for the second image sensor devices to control pan-tilt-zoom and observe the neighborhood takeover region.

The selecting includes, by comparing a time taken for the intruder to escape from the observation range of the first image sensor device to a time taken for the second image sensor devices to control pan-tilt-zoom and observe the neighborhood takeover region, selecting an image sensor device with the shorter time.

The method further includes, when the intruder is not able to be tracked through cooperation with the second image sensor devices, assigning a task to track the intruder to a spare image sensor device.

According to an aspect, there is provided a method of detecting an intruder based on a virtual fence, the method including detecting an object invading a virtual fence set in a protection area, when the detected object is an intruder, tracking the intruder, and controlling an observation range of an image sensor device by controlling PTZ of the image sensor device, in response to a command transmitted by a control center, and wherein the virtual fence is dynamically set through cooperation with image sensor devices adjacent to the image sensor device by controlling PTZ of the image sensor device.

According to an aspect, there is provided a device for monitoring an intruder based on a virtual fence, the device including a processor, and a memory electrically connected to the processor and configured to store instructions executable by the processor, wherein, when the instructions are executed by the processor, the processor is configured to perform a plurality of operations, and wherein the plurality of operations includes detecting an intruder invading a virtual fence set in a protection area by using a first image sensor device, and tracking the intruder through cooperation with second image sensor devices adjacent to the first image sensor device, based on information of the intruder.

The plurality of operations further includes dynamically setting the virtual fence through cooperation with the second image sensor devices by controlling pan-tilt-zoom of the first image sensor device.

The plurality of operations further includes setting initial location information at which the intruder is detected by the first image sensor device to be an identifier to distinguish the intruder.

The tracking includes, when the intruder escapes an observation range of the first image sensor device, selecting an image sensor device to track the intruder from among the second image sensor devices based on information of the intruder, and assigning a task to track the intruder to a selected image sensor device.

The tracking includes calculating a neighborhood takeover region, which is a dead zone of the first image sensor device and occurs as the first image sensor device tracks the intruder.

The neighborhood takeover region corresponds to a difference between an initial observation range of the first image sensor device and an updated observation range, which is updated based on tracking the intruder, of the first image sensor device.

The tracking further includes setting a range in which cooperation among the first image sensor device and the second image sensor devices is available based on a time taken for the intruder to escape from an observation range of an image sensor device and a time taken for the second image sensor devices to control PTZ and observe the neighborhood takeover region.

The selecting includes, by comparing a time taken for the intruder to escape from the observation range of the first image sensor device to a time taken for the second image sensor devices to control PTZ and observe the neighborhood takeover region, selecting an image sensor device with the shorter time.

The plurality of operations further includes, when the intruder is not able to be tracked through cooperation with the second image sensor devices, assigning a task to track the intruder to a spare image sensor device.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating an intruder detection system based on a virtual fence according to an example embodiment;

FIG. 2 is a schematic block diagram illustrating an image sensor device according to an example embodiment;

FIG. 3 is a schematic block diagram illustrating a control center according to an example embodiment;

FIG. 4 is a diagram illustrating an operation of operating a multiple image sensor device according to an example embodiment;

FIG. 5 is a diagram illustrating an operation of dynamically configuring and operating a virtual fence when an intruder invades a protection area, according to an example embodiment;

FIG. 6 is a diagram illustrating an operation of configuring an intruder protection area based on a dynamic virtual fence, according to an example embodiment;

FIG. 7 is a diagram illustrating an operation of managing an intruder protection area in a control center, according to an example embodiment;

FIG. 8 is a diagram illustrating a task of tracking an intruder based on cooperation between a plurality of image sensor devices, according to an example embodiment;

FIG. 9 is a flowchart illustrating a task procedure of an image sensor device for operating a dynamic virtual fence, according to an example embodiment; and

FIG. 10 is a flowchart illustrating a task procedure of a control center for operating a dynamic virtual fence, according to an example embodiment.

### DETAILED DESCRIPTION

The following detailed structural or functional description is provided as an example only and various alterations and modifications may be made to the examples. Here, the examples are not construed as limited to the disclosure and should be understood to include all changes, equivalents, and replacements within the idea and the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, examples will be described in detail with reference to the accompanying drawings. When describing the examples with reference to the accompanying drawings, like reference numerals refer to like components and a repeated description related thereto will be omitted.

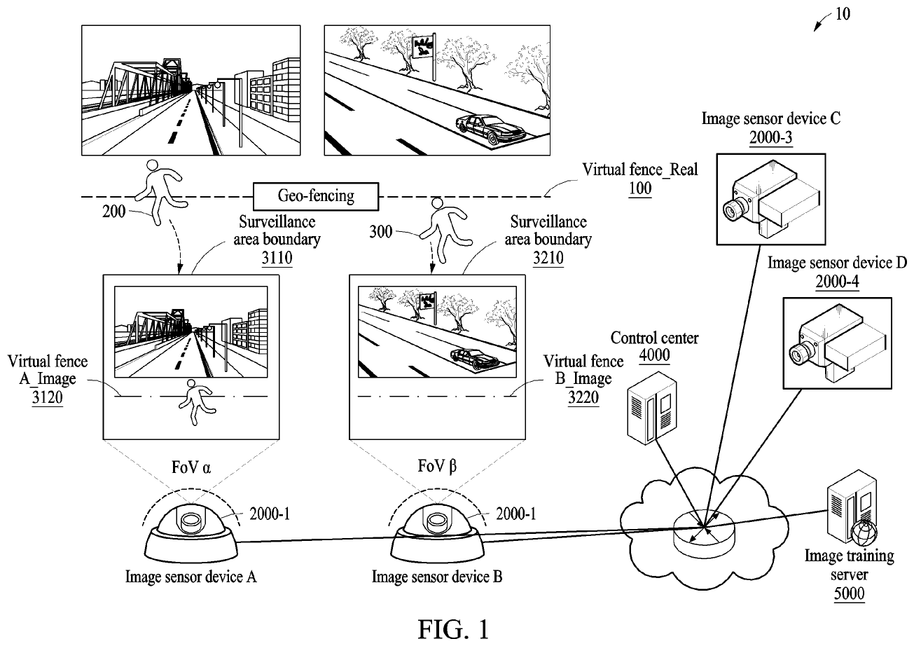

FIG. 1 is a diagram illustrating an intruder detection system based on a virtual fence according to an example embodiment.

Referring to FIG. 1, an intruder detection system 10 may include one or more image sensor devices 2000-1, 2000-2, 2000-3, and 2000-4 and a control center 4000. The image sensor devices 2000-1, 2000-2, 2000-3, and 2000-4 may be installed in a protection area to detect an invading object (e.g., intruders 200 and 300) that invades the protection area (or a surveillance area). The image sensor devices 2000-1, 2000-2, 2000-3, and 2000-4 may include a processor (e.g., a graphics processing unit (GPU)) configured to perform a camera and an image deep learning algorithm. The control center 4000 may control and manage the image sensor devices 2000-1, 2000-2, 2000-3, and 2000-4. Each of the image sensor devices 2000-1, 2000-2, 2000-3, and 2000-4 may interoperate with the control center 4000 via a wireless network or by wire. The intruder detection system 10 may further include an image learning server 5000.

The image sensor devices 2000-1, 2000-2, 2000-3, and 2000-4 may detect and track an intruder through a deep learning algorithm (e.g., You only look once (Yolo), a residual neural network (ResNet), RE3(Real-time Recurrent Regression), and the like) analysis for an image (e.g., an image captured by a camera) of a camera. For cameras of the image sensor devices 2000-1, 2000-2, 2000-3, and 2000-4, there are restrictions on a range in detecting and tracking an intruder due to an optical limitation, and thus, cooperation between the cameras may be needed to monitor the protection area.

To efficiently detect and track the intruding objects 200 and 300 intruding the protection area, a virtual fence (e.g., a virtual surveillance line or a fence line) 100 may be set to the protection area. The image sensor devices 2000-1, 2000-2, 2000-3, and 2000-4 may detect and track the intruders 200 and 300 through image deep learning for an object crossing the virtual fence 100. The virtual fence 100 (e.g., a virtual fence A_Image 3120 and a virtual fence B_Image 3220) may be installed in surveillance area boundaries 3110 and 3210, which are the size of an image observed (or obtained) through the cameras of the image sensor devices 2000-1, 2000-2, 2000-3, and 2000-4, and an object intruding the virtual fence 100 may be detected and tracked. The virtual fence A_Image 3120 may be the virtual fence 100 set in the surveillance area boundary 3110 observed by the camera of the image sensor device 2000-1 and the virtual fence B_Image 3220 may be the virtual fence 100 set in the surveillance area boundary 3210 observed by the camera of the image sensor device 2000-2.

The image sensor devices 2000-1, 2000-2, 2000-3, and 2000-4 may perform a function of detecting an intruder by downloading and mounting a model (e.g., an image deep learning algorithm) learned in the image learning server 5000. While detecting and tracking the intruder, each of the image sensor devices 2000-1, 2000-2, 2000-3, and 2000-4 may control a field of view (FoV) (e.g., FoVs α, β) through adjusting the lens magnification.

The control center 4000 may manage each of the image sensor devices 2000-1, 2000-2, 2000-3, and 2000-4 and when a movement path of an invading object (e.g., the intruders 200 and 300) is out of the surveillance area of the image sensor device (e.g., the image sensor devices 2000-1 and 2000-2), may allocate a task to an adjacent image sensor device (e.g., the image sensor device 2000-3) or a spare image sensor device to track a predetermined intruder (e.g., the intruders 200 and 300).

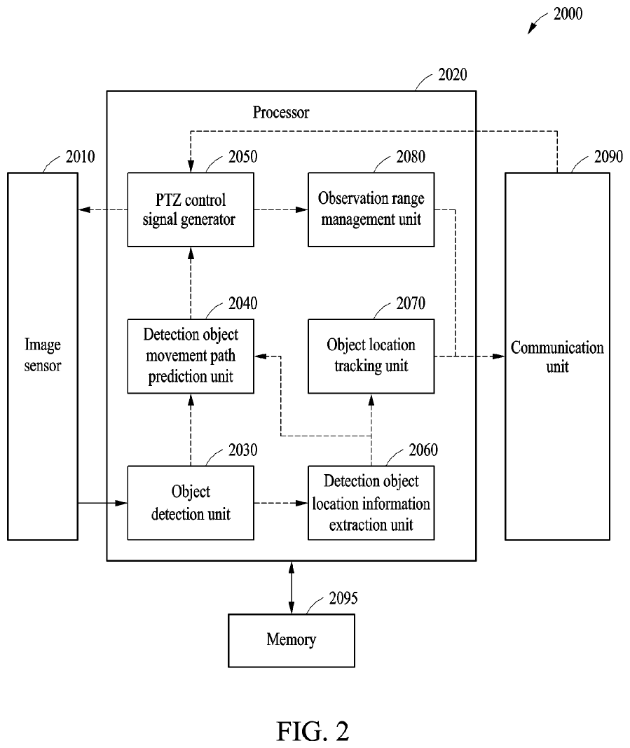

FIG. 2 is a schematic block diagram illustrating an image sensor device according to an example embodiment.

Referring to FIG. 2, according to an example embodiment, an image sensor device 2000 (e.g., the image sensor devices 2000-1, 2000-2, 2000-3, and 2000-4) may include an image sensor 2010 (e.g., a camera), a processor 2020, and a communication unit 2090. The image sensor device 2000 may further include a memory 2095.

The memory 2095 may store instructions (or programs) executable by the processor 2020. For example, the instructions include instructions for performing the operation of the processor 2020 and/or an operation of each component of the processor 2020.

The memory 2095 may include one or more of computer-readable storage media. The memory 2095 may include non-volatile storage elements (e.g., a magnetic hard disk, an optical disc, a floppy disc, a flash memory, electrically programmable memory (EPROM), and electrically erasable and programmable memory (EEPROM).

The memory 2095 may be a non-transitory medium. The term “non-transitory” may indicate that the storage medium is not embodied in a carrier wave or a propagated signal. However, the term “non-transitory” should not be interpreted to mean that the memory 2095 is non-movable.

The processor 2020 may process data stored in the memory 2095. The processor 2020 may execute computer-readable code (e.g., software) stored in the memory 2095 and instructions triggered by the processor 2020.

The processor 2020 may be a hardware-implemented data processing device having a circuit that is physically structured to execute desired operations. For example, the desired operations may include code or instructions included in a program.

The hardware-implemented data processing device may include, for example, a microprocessor, a central processing unit (CPU), a processor core, a multi-core processor, a multiprocessor, an application-specific integrated circuit (ASIC), and a field-programmable gate array (FPGA).

The processor 2020 may include an object detection unit 2030, a detection object movement path prediction unit 2040, a pan-tilt-zoom (PTZ) control signal generator 2050, a detection object location information extraction unit 2060, an object location tracking unit 2070, and an observation range management unit 2080. The objection detection unit 2030, the detection object movement path prediction unit 2040, the PTZ control signal generator 2050, the detection object location information extraction unit 2060, the object location tracking unit 2070, and the observation range management unit 2080 may be embedded in the processor 2020 or may be loaded to the processor 2020 from the memory 2095.

The image sensor 2010 (e.g., a camera) may transmit a captured image to the object detection unit 2030. The object detection unit 2030 may detect an object in an image (or a screen) using an image deep learning algorithm and then may determine whether the detected object is an intruder. When the detected object is determined to be an intruder, the object detection unit 2030 may transmit information of the intruder to the detection object movement path prediction unit 2040 and the detection object location information extraction unit 2060.

The detection object location information extraction unit 2060 may extract location information of the detected object by combining a location of the object in the image (or the screen) and PTZ information mounted in the image sensor device 2000. The PTZ information may be obtained from the image sensor 2010 and/or the image sensor device 2000. The detection object location information extraction unit 2060 may transmit the location information of the detected object to the object location tracking unit 2070. That is, the location information of the detected object may be information obtained by converting the location of the detected object into global positioning system (GPS) location information by combining the size of a bounding box and coordinates of the detected object in the image and the PTZ information of the image sensor 2010 equipped with the GPS.

The object location tracking unit 2070 may track the location of the detected object in the unit of frames in the image. The detection object movement path prediction unit 2040 may control PTZ of the image sensor 2010 by predicting the movement path of the detected object based on the tracked information. In addition, the object location tracking unit 2070 may transmit the movement path of the detected object to the control center 4000 via the communication unit 2090 such that the control center 4000 may display the movement path of the detected object. The detection object movement path prediction unit 2040 may generate a movement path (or an estimated movement path) of the detected object based on information of the detected object, such as a moving direction and a speed, in real-time and may transmit the movement path of the detected object to the PTZ control signal generator 2050.

The PTZ control signal generator 2050 may control the image sensor 2010 by generating a PTZ control signal (e.g., a PTZ control signal for the image sensor 2010) based on the movement path of the detected object. The PTZ control signal generator 2050 may generate the PTZ control signal in response to a control command (e.g., a command for the control center 4000 to directly control the image sensor 2010) transmitted from the control center 4000.

The PTZ control signal generator 2050 may also transmit the generated PTZ control signal to the observation range management unit 2080. In response to the PTZ control signal, the observation range management unit 2080 may update a currently observable range of the image sensor 2010 in real time based on a characteristic (e.g., a zoom magnification characteristic and an FoV table characteristic) of the image sensor 2010 and may transmit updated information to the control center 4000 via the communication unit 2090.

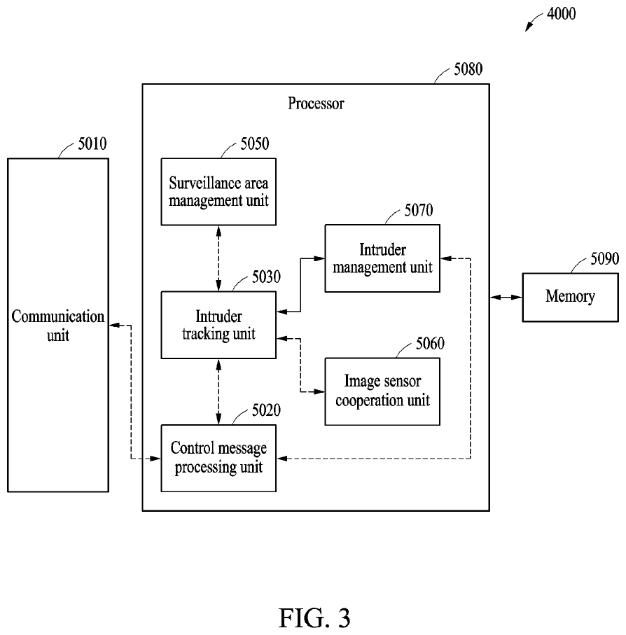

FIG. 3 is a schematic block diagram illustrating a control center according to an example embodiment.

Referring to FIG. 3, the control center 4000 (e.g., a control server device) may include a communication unit 5010 and a processor 5080. The control center 4000 may further include a memory 5090.

The communication unit 5010 may perform a communication function with the image sensor device 2000 (e.g., each of the image sensor devices 2000-1 to 2000-4 of FIG. 1). The memory 5090 may store instructions (or programs) executable by the processor 5080. For example, the instructions include instructions for performing the operation of the processor 5080 and/or an operation of each component of the processor 5080.

The memory 5090 may include one or more of computer-readable storage media. The memory 5090 may include non-volatile storage elements (e.g., a magnetic hard disk, an optical disc, a floppy disc, a flash memory, EPROM, and EEPROM.

The memory 5090 may be a non-transitory medium. The term “non-transitory” may indicate that the storage medium is not embodied in a carrier wave or a propagated signal. However, the term “non-transitory” should not be interpreted to mean that the memory 5090 is non-movable.

The processor 5080 may process data stored in the memory 5090. The processor 5080 may execute computer-readable code (e.g., software) stored in the memory 5090 and instructions triggered by the processor 5080.

The processor 5080 may be a hardware-implemented data processing device having a circuit that is physically structured to execute desired operations. For example, the desired operations may include code or instructions included in a program.

The hardware-implemented data processing device may include, for example, a microprocessor, a CPU, a processor core, a multi-core processor, a multiprocessor, an ASIC, and an FPGA.

The processor 5080 may include a control message processing unit 5020, an intruder tracking unit 5030, a surveillance area management unit 5050, a surveillance area management unit 5050, an image sensor cooperation unit 5060, and an intruder management unit 5070. The control message processing unit 5020, the intruder tracking unit 5030, the surveillance area management unit 5050, the image sensor cooperation unit 5060, and the intruder management unit 5070 may be embedded in the processor 5080 or may be loaded to the processor 5080 from the memory 5090.

The control message processing unit 5020 may generate a message (e.g., a command) for controlling the image sensor 2010 of the image sensor device 2000 and may transmit the message to the image sensor device 2000 via the communication unit 5010. The intruder tracking unit 5030 may track a location of a detected object (e.g., an intruder). The surveillance area management unit 5050 may manage a surveillance area of the image sensor device 2000 (e.g., the image sensor devices 2000-1 to 2000-4 of FIG. 1) in real time. When an intruder detected by an image sensor device (e.g., the image sensor device A 2000-1 of FIG. 1) moves and escapes an observation range of the image sensor device, the image sensor cooperation unit 5060 may assign a task to another image sensor device (e.g., the image sensor device C 2000-3 of FIG. 1) to continuously track the intruder. The intruder management unit 5070 may manage an intruder appearing in the surveillance area (e.g., an intruder surveillance area) by assigning a unique identifier to the intruder. For example, a method of assigning a unique identifier to each intruder may include a method of designating a unique identifier with a GPS time when the intruder is initially detected and continuously managing a movement path of the intruder.

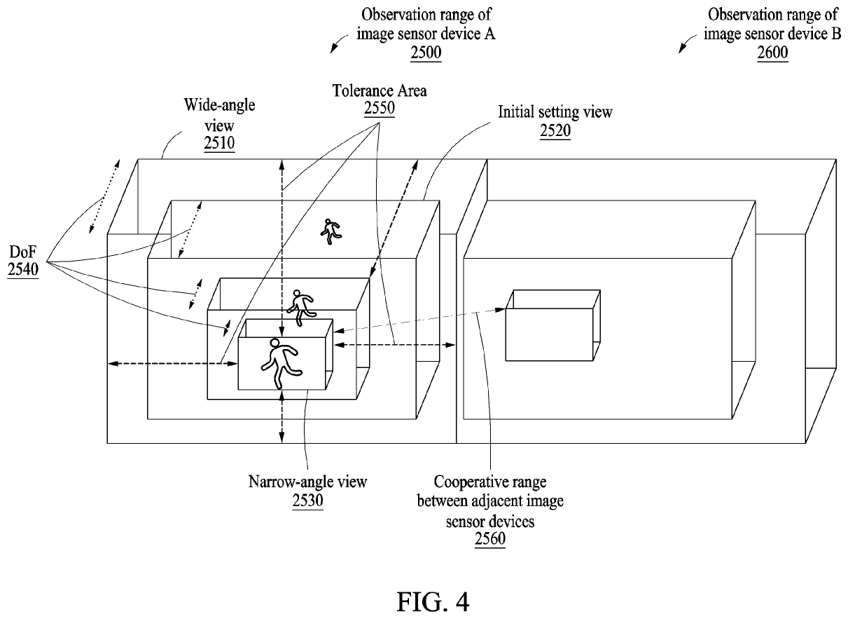

FIG. 4 is a diagram illustrating an operation of operating a multiple image sensor device according to an example embodiment.

FIG. 4 is a diagram illustrating an operation of operating an image sensor device in an observation range 2500 (or a capture range) of the image sensor device A 2000-1 of FIG. 1 and an observation range 2600 of the image sensor device B 2000-2 of FIG. 1.

An image sensor (e.g., the image sensor 2010 of FIG. 2), in other words, a camera, may obtain an image for detecting an intruder by setting a narrow-angle view 2530 that enlarges an image size of a subject by increasing the magnification of a lens from a wide-angle view 2510 in which the magnification of the lens is 1. In the wide-angle view 2510, a range of observing an intruder is wide but since the size of an intruder is small, detecting the intruder with image deep learning may be difficult. When the magnification of the camera lens increases (zoom in) to overcome this problem, the image size of the subject may increase, however, the observation range may decrease.

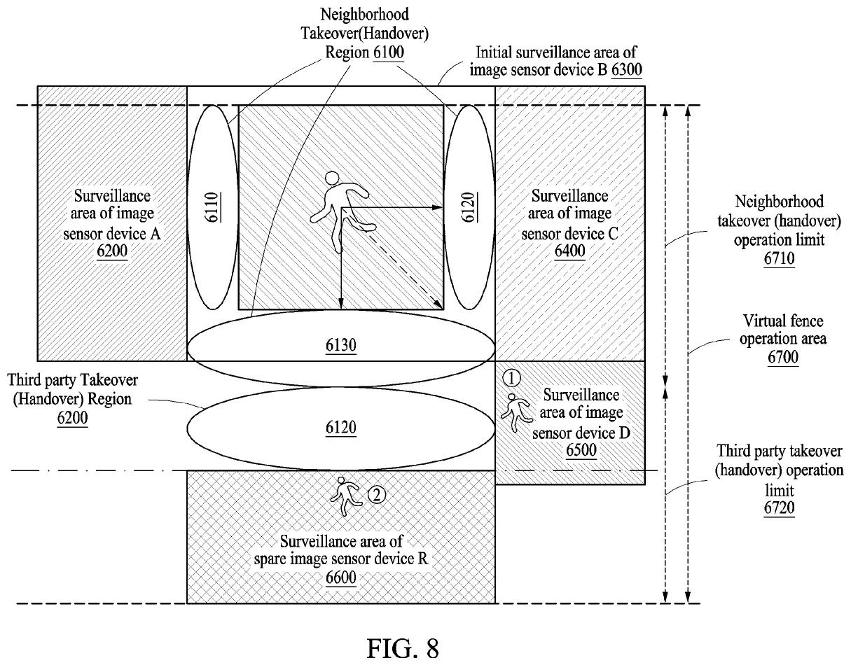

Referring to FIG. 4, an image sensor device (e.g., the image sensor device A 2000-1 and the image sensor device B 2000-2) may set an initial setting view 2520 (e.g., an initial surveillance area) by adjusting the magnification of a lens of the image sensor 2010. After setting the initial setting view 2520, the image sensor device (e.g., the image sensor device A 2000-1 and the image sensor device B 2000-2) may begin a task of detecting an intruder (e.g., a detected object) and may obtain a clear image of the intruder or track the intruder as the intruder moves. A screen of the image sensor 2010 when PTZ of the image sensor 2010 is controlled to track the intruder may be the screen 2530. In this case, as the screen of the image sensor 2010 decreases (e.g., from 2520 to 2530), a difference from the original wide-angle view 2510 may occur and this may be referred to as a tolerance area 2550 (e.g., an observation range). That is, the image sensor device (e.g., the image sensor device A 2000-1 and the image sensor device B 2000-2) may detect or track the intruder by freely controlling the PTZ of the image sensor 2010 in the range of the tolerance area 2550. A neighborhood takeover (handover) region 6710 or a third party takeover (handover) region 6200 of FIG. 8 may be determined in the range of the tolerance area 2550.

By considering an environment in which a plurality of image sensor devices (e.g., the image sensor device A 2000-1 and the image sensor device B 2000-2) is installed and operated, when an observation dead zone occurs as the observation range 2500 of the image sensor device A 2000-1 decreases, the image sensor device B 2000-2 (e.g., an image sensor device adjacent to the image sensor device A 2000-1) may perform an intruder surveillance task in the dead zone.

In an environment in which the plurality of image sensor devices operates, a cooperative range 2560 between adjacent image sensor devices may be set. The cooperative range 2560 may be set in a range in which t_setup is less than t_out by comparing t_out to t_setup, where t_out is the time taken for the intruder to escape the narrow-angle view 2530 based on an average moving speed of the intruder and t_setup is the time taken for an adjacent image sensor device (e.g., the image sensor device B 2000-2) to control PTZ of the image sensor 2010 and observe the tolerance area 2550 of the image sensor device A 2000-1. In addition, since a clear image may be obtained only in a range of a depth of field 2540 of the image sensor 2010 when controlling the lens magnification of the image sensor 2010, a method of preemptively controlling the magnification of a camera lens by considering the moving speed of the intruder may be used.

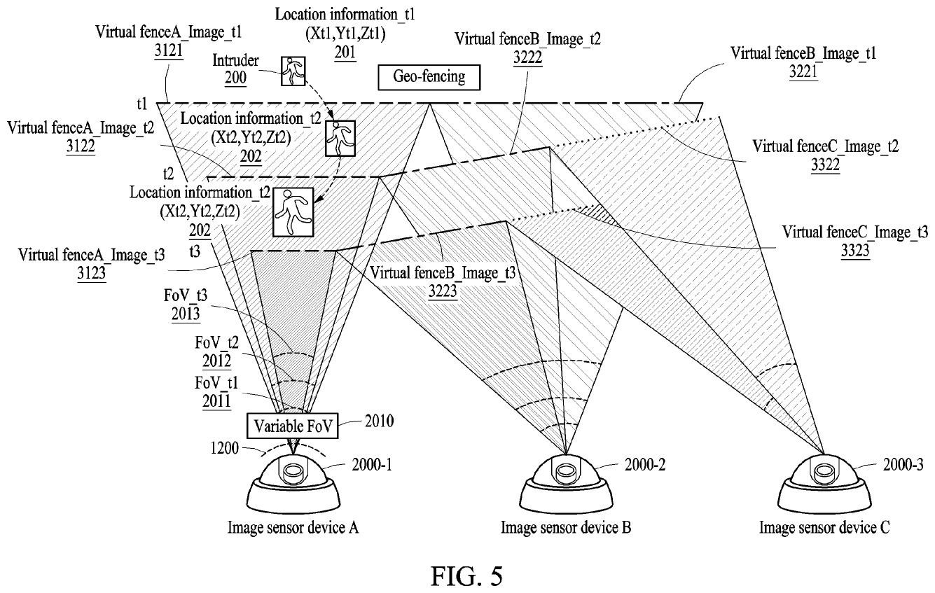

FIG. 5 is a diagram illustrating an operation of dynamically configuring and operating a virtual fence when an intruder invades a protection area, according to an example embodiment. The image sensor device A 2000-1 having a variable FoV 2010 at a time t1 may monitor an intruder 200 by configuring a virtual fence A_Image_t1 3121 and the image sensor device B 2000-2 may monitor the intruder 200 by configuring a view fence B_Image_t1 3221.

An FoV of a camera of the image sensor device 2000-1 that monitors the intruder 200 of which location information at the time t1 is “location information_t1 (Xt1, Yt1, Zt1) 201” may be an FoV_t1 2011, and the image sensor device 2000-1 may detect the intruder 200 through deep learning on a captured image. Thereafter, when the intruder continues invading by crossing a virtual fence (e.g., the virtual fence 100 of FIG. 1) and location information at a time t2 corresponds to location information_t2 (Xt2, Yt2, Zt2) 202, the image sensor device A 2000-1 may adjust the FoV of the image sensor 2010 to an FoV_t2 2012 to enlarge the image of the intruder 200 to precisely and continuously track the intruder 200. Although a large image may be obtained by increasing the lens magnification of the image sensor 2010, the FoV of the image sensor device A 2000-1 may decrease to the FoV_t2 2012 and the surveillance area for the virtual fence may decrease, and thus, the image sensor device A 2000-1 may configure a virtual fence A_Image_t2 3122.

To compensate for the decreased surveillance area of the image sensor device A 2000-1, the image sensor device B 2000-2 may configure a virtual fence B_Image_t2 3222 by controlling PTZ of the image sensor 2010 included in the image sensor device 2000-2. Accordingly, to compensate for the decrease of the surveillance area, the image sensor device C 2000-3 may also configure a virtual fence C_Image_t2 3322 by controlling PTZ of the image sensor 2010 included in the image sensor device C 2000-3. As described above, the virtual fence (e.g., the virtual fence 100 of FIG. 1) may change and be set to a shape in which a straight line and a diagonal line are combined from an initial (e.g., at the time t1) straight line shape.

Thereafter, when an intruder continuously invades inside the protection area, the image sensor device A 2000-1 may adjust the FoV of the image sensor 2010 of the image sensor device A 2000-1 to an FoV_t3 2013 and may configure a virtual fence A_Image_t3 3123. Accordingly, to compensate for the surveillance area of the image sensor device A 2000-1, the image sensor device B 2000-2 may configure the virtual fence B_Image_t3 3222 by controlling PTZ of the image sensor 2010 included in the image sensor device B 2000-2 and the image sensor device C 2000-3 may also configure a virtual fence C_Image_t3 3223 by controlling PTZ of the image sensor 2010 included in the image sensor device C 2000-3. In this case, location information of the intruder 200 may be location information_t3 (Xt3, Yt3, Zt3) 203.

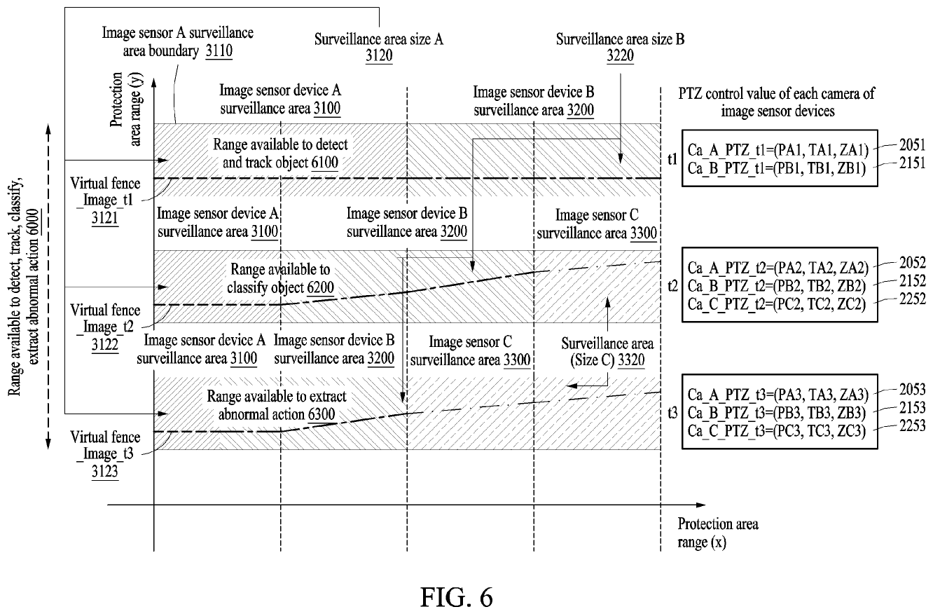

FIG. 6 is a diagram illustrating an operation of configuring an intruder protection area based on a dynamic virtual fence, according to an example embodiment.

FIG. 6 may represent surveillance areas 3100, 3200, and 3300, which are respectively in charge of the image sensor devices 2000, 2100, and 2200 when an intruder protection area is configured based on the operation of operating the dynamic virtual fence described with reference to FIG. 5. The surveillance area 3100 of the image sensor device A 2000-1 may include a surveillance area boundary 3110 of the image sensor device A 2000-1 and a surveillance area size A 3120, and may be differently constituted by “a virtual fence_Image_t1 3121, a virtual fence_Image_t2 3122, and a virtual fence_Image_t3 3123” by observation time. Similarly, the size of the surveillance area 3200 of the image sensor device B 2000-2 may be the same as a surveillance area size B 3220 and the size of the surveillance area 3300 of the image sensor device C 2000-3 may be the same as a surveillance area size C 3320. An image captured by the image sensor 2010 of each of the image sensor devices 2000-1 to 2000-3 may show a clear outline in case of an object within a depth of field of the image sensor 2010, and thus, an area in which an object may be detected by image deep learning may be determined. An observation range (e.g., a camera observation range) of the image sensor devices 2000-1 to 2000-3 may be determined based on a PTZ control value of the image sensor 2010 included in a device.

At the time t1, a camera PTZ control value of the image sensor device A 2000-1 may be Ca_A_PTZ_t1=(PA1, TA1, ZA1) 2051 and a camera PTZ control value of the image sensor device B 2000-2 may be Ca_B_PTZ_t1=(PB1, TB1, ZB1) 2151. At the time t2, a camera PTZ control value of the image sensor device A 2000-1 may be a_A_PTZ_t2=(PA2, TA2, ZA2) 2052, a camera PTZ control value of the image sensor device B 2000-2 may be Ca_B_PTZ_t2=(PB2, TB2, ZB2) 2152, and a camera PTZ control value of the image sensor device C 2000-3 may be Ca_C_PTZ_t2=(PC2, TC2,ZC2) 2252. At the time t3, a camera PTZ control value of the image sensor device A 2000-1 may be a_A_PTZ_t3=(PA3, TA3, ZA3) 2053, a camera PTZ control value of the image sensor device B 2000-2 may be Ca_B_PTZ_t3=(PB3, TB3, ZB3) 2153, and a camera PTZ control value of the image sensor device C 2000-3 may be Ca_C_PTZ_t2=(PC3, TC3, ZC3) 2253. A range available to detect, track, and classify an intruder and extract an abnormal action with the image sensor devices 2000-1 to 2000-3 may be the same as a range 6000. As illustrated in FIG. 6, at the time t1, the virtual fence_Image_t1 3121 corresponding to a range 6100 available to detect and track an invading object may be set, at the time t2, the virtual fence_Image_t2 3122 corresponding to a range 6200 available to classify and track the invading object may be set, and at the time t3, the virtual fence_Image_t3 3123 corresponding to a range (or a distance) 6300 available to extract an abnormal action of the invading object may be set.

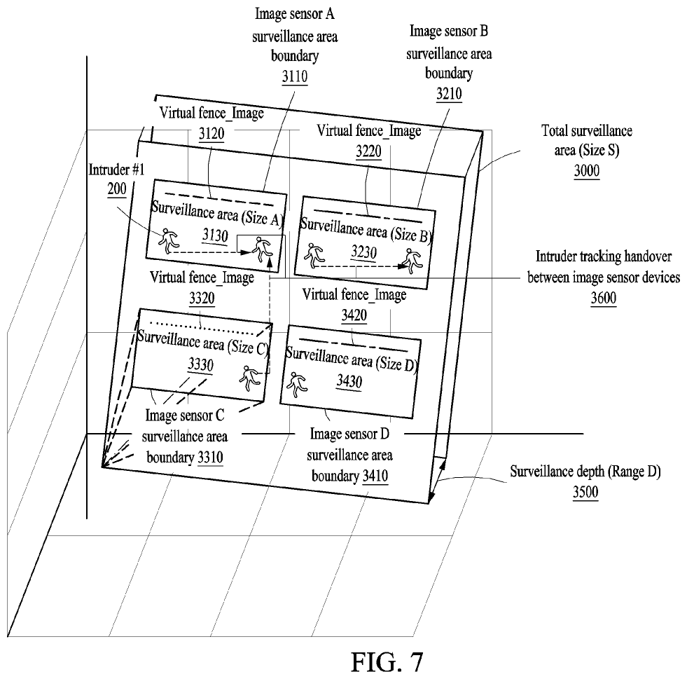

FIG. 7 is a diagram illustrating an operation of managing an intruder protection area in a control center, according to an example embodiment.

The control center 4000 may control a surveillance area of the image sensor devices 2000, 2100, 2200, and 2300 for detecting an invading object (e.g., an intruder) to an intruder protection area and settings of the virtual fences 3120, 3220, 3320, and 3420. In addition, the control center 4000 may track the movement of detected intruders 200, 210, and 220.

In FIG. 7, it is supposed that the total size of a surveillance area 3000 of the intruder protection area is S and the sizes of areas respectively monitored by the image sensor devices 2000-1 to 2000-4 are A 3130, B 3230, C 3330, and D 3430. The image sensor 2010 of each of the image sensor devices 2000-1 to 2000-4 may be set such that the sum of the areas monitored by each of the image sensor devices 2000-1 to 2000-4 is S.

Based on an assumption that characteristics of the image sensors 2010 of each of the image sensor devices 2000-1 to 2000-4 installed in the intruder protection area are the same, the limit to monitor an intruder by the image sensor devices 2000-1 to 2000-4 may be a monitor depth 3500 (e.g., a range D) by considering the depth of the image sensor 2010 and the magnification of the lens. Each of the image sensor devices 2000-1 to 2000-4 and the control center 4000 may detect and track an intruder through cooperation as in the following example scenario.

\textcircled{1} It is assumed that, at the time t1, the intruder #1 200 appears in a surveillance area boundary 3110 of the image sensor device A 2000-1, the intruder #2 210 appears in a surveillance area boundary 3410 of the image sensor device D 2000-4, and the intruder #3 220 appears in a surveillance area boundary 3310 of the image sensor device C 2000-3. Since the intruders 200, 210, and 220 are inside the virtual fences 3120, 3420, and 3320, each of the image sensor devices 2000-1, 2000-3, and 2000-4 may detect the intruders 200, 210, and 220 through image deep learning, extract location information (e.g., location information (X1, Y1, Z1) of the intruder #1 200, location information (X2, Y2, Z2) of the intruder #2 210, and location information (X3, Y3, Z3) of the intruder #3 220) of the detected intruders 200, 210, and 220, and may continuously track movement paths of the detected intruders 200, 210, and 220 based on a frame of the image and transmit related information (e.g., tracking information) to the control center 4000. The control center 4000 may divide the entire surveillance area into areas respectively monitored by the image sensor devices 2000-1 to 2000-4 and manage the areas. In addition, the control center 4000 may use the location information of the intruders detected by each of the image sensor devices 2000-1, 2000-3, and 2000-4 as an intruder identifier and may manage as follows.
An identifier of the intruder #1 200: A_X1, Y1, Z1, an attribute of the intruder #1 200: A, X1_t1, Y1_t1, Z1_t1
An identifier of the intruder #2 210: D_X2, Y2, Z2, an attribute of the intruder #2 210: D, X2_t1, Y2_t1, Z2_t1
An identifier of the intruder #3 220: C_X3, Y3, Z3, an attribute of the intruder #3 220: A, X3_t1, Y3_t1, Z3_t1
\textcircled{2}It is assumed that, at the time t2, the intruder #1 200 moves to the inside of the surveillance area boundary 3210 of the image sensor device B 2000-2, the intruder #2 210 also moves to the inside of the surveillance area boundary 3210 of the image sensor device B 2000-2, and the intruder #3 220 moves to the inside of the surveillance area boundary 3110 of the image sensor device A 2000-1. Each of the image sensor devices 2000-1 to 2000-4 may continuously track and transmit, to the control center 4000, a moving direction and speed of a detected object (e.g., an intruder) after the time tl when the intruder is detected. The control center 4000 may determine in which surveillance area direction the intruder moves and which image sensor device (e.g., the image sensor device A 2000-1 and the image sensor device B 2000-2) monitors the surveillance area and may notify (e.g., an intruder tracking handover start message) to the corresponding image sensor device (e.g., the image sensor device A 2000-1 and the image sensor device B 2000-2). The image sensor device (e.g., the image sensor device A 2000-1 and the image sensor device B 2000-2) receiving the notification may transmit an approval message (e.g., an intruder tracking handover approval) to the control center 4000 when the image sensor device determines that the intruder is trackable. Thereafter, the image sensor device (e.g., the image sensor device A 2000-1 and the image sensor device B 2000-2) that approved intruder tracking handover may continuously track the handed over intruder when controlling PTZ of the image sensor 2010 and may simultaneously perform a task to monitor a new intruder. In this case, the attributes of the intruder managed by the control center 4000 are as follows.
An identifier of the intruder #1 200: A_X1, Y1, Z1, an attribute of the intruder #1 200: A_B, X1_t2, Y1_t2, Z1_t2
An identifier of the intruder #2 210: D_X2, Y2, Z2, an attribute of the intruder #2 210: D_B, X2_t2, Y2_t2, Z2_t2
An identifier of the intruder #3 220: C_X3, Y3, Z3, an attribute of the intruder #3 220: C_A, X3_t2, Y3_t2, Z3_t2

FIG. 8 is a diagram illustrating a task of tracking an intruder based on cooperation between a plurality of image sensor devices, according to an example embodiment.

As illustrated in FIG. 8, an initial surveillance area 6300 of the image sensor device B 2000-2 may be adjacent to a surveillance area 6200 of the image sensor device A 2000-1, a surveillance area 6400 of the image sensor device C 2000-3, and a surveillance area 6500 of the image sensor device D 2000-4. As an intruder appears in the surveillance area 6300, the image sensor device B 2000-2 reduces the screen of the image sensor 2010 while detecting the intruder by adjusting the PTZ and lens magnification of the image sensor 2010, and thus, a dead zone of the surveillance area 6300 may occur. The dead zone may be supplemented through cooperation with the adjacent image sensor devices 2000-1, 2000-3, and 2000-4 and the image sensor 2010. The dead zone may be referred to as neighborhood takeover (or handover) regions 6110, 6120, and 6130.

When a dead zone occurs in an observation range (e.g., the surveillance area), the control center 4000 may analyze states (e.g., whether an intruder is detected and tracked, the current camera observation range) of the adjacent image sensor devices 2000-1, 2000-3, and 2000-4 and may remove the dead zone by transmitting a PTZ control command to the image sensor devices 2000-1, 2000-3, and 2000-4, which are adjacent to the dead zone, to monitor regions including the neighborhood takeover (handover) regions 6110, 6120, and 6130. In response to the PTZ control command transmitted by the control center 4000, each of the image sensor devices 2000-1, 2000-3, and 2000-4 may estimate a moving direction of the intruder by analyzing an image in the unit of frames and may provide information of the intruder (e.g., a moving direction and a moving speed of the intruder and current coordinates information) to the control center 4000. The control center 4000 receiving the information of the intruder may select a target image sensor device to continuously track the intruder when the intruder escapes the area of the current observation image sensor device (e.g., the image sensor device B 2000-2) and may assign an intruder tracking task to the selected image sensor device.

In FIG. 8, when the intruder moves in the direction of \textcircled{1}, the image sensor device D 2000-4 may receive a task to track the intruder from the control center 4000 and may perform the task to track the intruder When the intruder moves in the direction of \textcircled{2} and there is no image sensor device nearby, the control center 4000 may send a surveillance command to a spare image sensor device R to monitor the third party takeover (handover) region 6200. As described above, a virtual fence operation area 6700, a neighborhood takeover (handover) operation limit 6710, and a third party takeover (handover) operation limit 6720 may be the same as illustrated in FIG. 8.

In addition, as the intruder moves, an observation task of an image sensor device that monitors the intruder may be performed as follows.

\textcircled{1} When the observation range (area) of the image sensor device decreases to within a predetermined threshold S_{Th1},
When the observation range that decreased based on the moving speed and direction of the intruder falls in the range S_{Th_N} in which the intruder is trackable without cooperation with the adjacent image sensor device, for a predetermined period, the image sensor device may continuously track the intruder.

STh_N <=Current observation range S_{c}<=S_{Th1} [Equation 1]
When the observation range that decreased based on the moving speed and direction of the intruder decreases by more than the range S_{Th_N} in which the intruder is trackable only through cooperation with the adjacent image sensor device, the image sensor device may perform a task to track the intruder in the neighborhood takeover (handover) region.

Current observation range S_{c}<=S_{Th1} and S_{Th_N} [Equation 2]

\textcircled{2}When the observation range (area) of the image sensor device decreases by more than a predetermined threshold S_{Th1},
The control center 4000 may perform a task to track the intruder through a spare image sensor device for monitoring the third party takeover (handover) region.

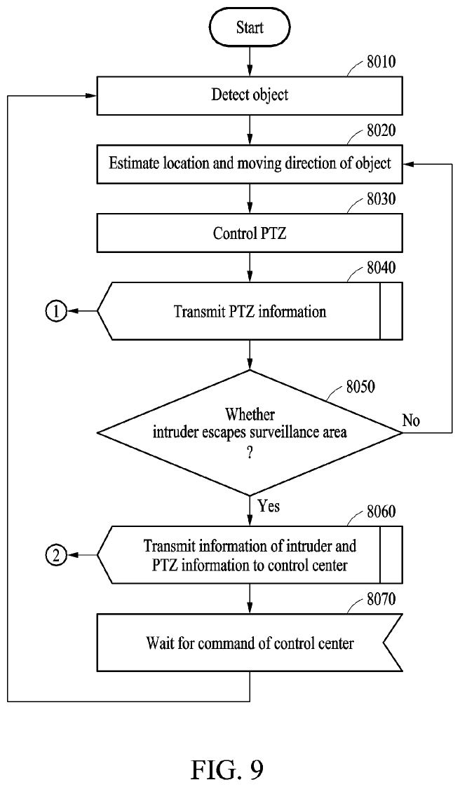

FIG. 9 is a flowchart illustrating a task procedure of an image sensor device for operating a dynamic virtual fence, according to an example embodiment.

In operation 8010, an image sensor device (e.g., the image sensor devices 2000-1 to 2000-4 of FIG. 1) may detect an object by performing deep learning on an image obtained by the image sensor 2010 and may determine whether the detected object is an intruder.

In operation 8020, when the detected object is an intruder, the image sensor device 2000 may estimate information of the intruder (e.g., a location and a moving direction of an intruder) based on an image frame.

In operation 8030, the image sensor device 2000 may track the intruder by controlling PTZ of the image sensor 2010 based on the information of the intruder. In operation 8040, the image sensor device 2000 may transmit PTZ information to the control center 4000. The control center 4000 may manage an observation range of the image sensor device 2000 (e.g., the image sensor devices 2000-1 to 2000-4) based on the PTZ information.

In operation 8050, the intruder may analyze (e.g., determine) whether the intruder escapes the surveillance area of the image sensor device 2000 that is currently detecting the intruder. When the intruder does not escape the surveillance area, the image sensor device 2000 may continuously track the intruder and may transmit the information of the intruder to the control center through operations 8020 to 8050.

In operation 8060, when the intruder escapes the surveillance area, to assign a tracking task for the intruder to an adjacent image sensor device and/or a spare image sensor device, the image sensor device 2000 may transmit the information of the intruder (e.g., a moving direction and a moving speed of an intruder) and the PTZ information to the control center 4000.

In operation 8070, the image sensor device 2000 may wait for a command of the control center 4000. The image sensor device 2000 may continuously detect and track an object while waiting.

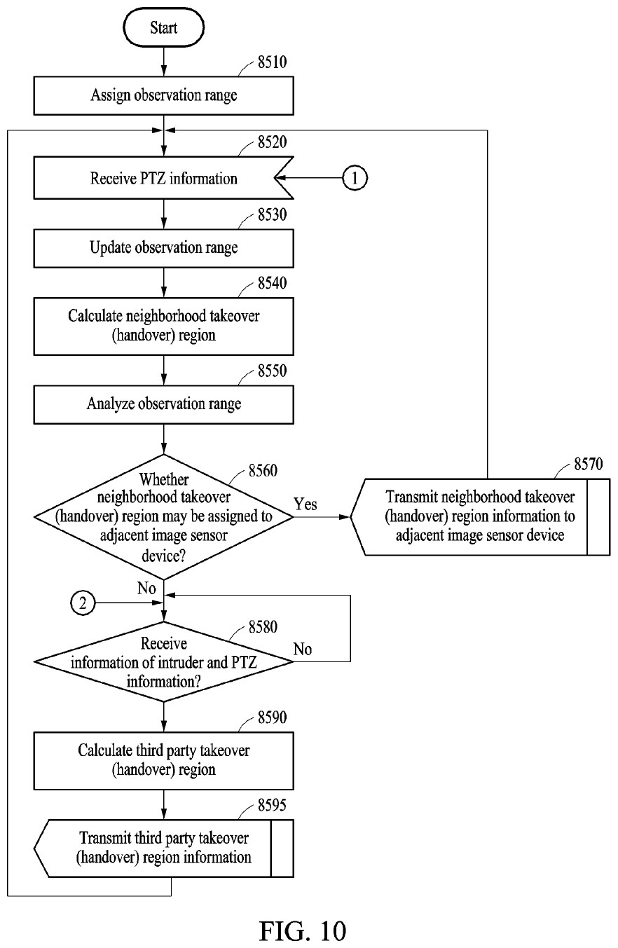

FIG. 10 is a flowchart illustrating a task procedure of a control center for operating a dynamic virtual fence, according to an example embodiment.

In operation 8510, the control center 4000 may initially assign an observation range of each image sensor device (e.g., the image sensor devices 2000-1 to 2000-4).

In operation 8520, the control center 4000 may receive PTZ information transmitted by each of the image sensor devices 2000-1 to 2000-4.

In operation 8530, the control center 4000 may continuously update the observation range of each of the image sensor devices 2000-1 to 2000-4 based on the PTZ information.

In operation 8540, the control center 4000 may calculate a neighborhood takeover (handover) region that is a dead zone which occurs while each of the image sensor devices 2000-1 to 2000-4 detects and tracks the intruder. A difference between the initial observation range of the image sensor devices 2000-1 to 2000-4 and the updated observation range of the image sensor devices 2000-1 to 2000-4 may be the neighborhood takeover (handover) region.

In operation 8550, the control center 4000 may analyze the observation range of the adjacent image sensor devices 2000-1 to 2000-4.

In operation 8560, the control center 4000 may analyze whether the adjacent image sensor devices 2000-1 to 2000-4 may take charge of the neighborhood takeover (handover) region. A parameter setting a takeover (handover) reference of the adjacent image sensor device 4000 may be determined as follows.

(1) A moving direction of the intruder: select an image sensor device that is adjacent to the moving direction of the intruder to be a handover target image sensor device.

(2) A moving speed of the intruder: based on an assumption that a time taken for the intruder to escape from the observation range of the current image sensor device is I_t and a set-up time taken for the adjacent image sensor device to observe the neighborhood takeover (handover) region by controlling PTZ is N_S_t by estimating the moving speed of the intruder,
When I_t≥N_S_t: perform a neighborhood takeover (handover) procedure.

(3) When a time taken for the spare image sensor device to control PTZ and to be stable to observe the neighborhood takeover (handover) region,
When N_S_t≥R_S_t: perform third party takeover (handover) region procedure.

In operation 8570, when the neighborhood takeover (handover) procedure is necessary, the control center 4000 may assign a tracking task for the intruder to the adjacent image sensor device by transmitting neighborhood takeover (handover) region information.

In operation 8580, when a camera setup time taken for tracking the intruder with the adjacent image sensor device is long or there is no adjacent image sensor device, the control center 4000 may continuously receive information of the intruder (e.g., a moving direction and a moving speed of an intruder) and PTZ information from the image sensor device.

In operations 8590 and 8595, the control center 4000 may calculate the third takeover (handover) region and may assign a task to track the intruder by transmitting information related to the calculation to the spare image sensor device.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The examples described herein may be implemented using hardware components, software components and/or combinations thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or pseudo equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

What is claimed is:

1. A method of detecting an intruder based on a virtual fence, the method comprising:
detecting an intruder invading a virtual fence set in a protection area by using a first image sensor device; and
tracking the intruder through cooperation with second image sensor devices adjacent to the first image sensor device, based on information of the intruder.

2. The method of claim 1, further comprising:
dynamically setting the virtual fence through cooperation with the second image sensor devices by controlling pan-tilt-zoom of the first image sensor device.

3. The method of claim 1, further comprising:
setting initial location information at which the intruder is detected by the first image sensor device to be an identifier to distinguish the intruder.

4. The method of claim 1, wherein the tracking comprises:
when the intruder escapes an observation range of the first image sensor device, selecting an image sensor device to track the intruder from among the second image sensor devices based on information of the intruder; and
assigning a task to track the intruder to a selected image sensor device.

5. The method of claim 4, wherein the tracking further comprises:
calculating a neighborhood takeover region, which is a dead zone of the first image sensor device and occurs as the first image sensor device tracks the intruder.

6. The method of claim 5, wherein the neighborhood takeover region corresponds to a difference between an initial observation range of the first image sensor device and an updated observation range, which is updated based on tracking the intruder, of the first image sensor device.

7. The method of claim 5, wherein the tracking further comprises:
setting a range in which cooperation among the first image sensor device and the second image sensor devices is available based on a time taken for the intruder to escape from an observation range of the first image sensor device and a time taken for the second image sensor devices to control pan-tilt-zoom and observe the neighborhood takeover region.

8. The method of claim 5, wherein the selecting comprises, by comparing a time taken for the intruder to escape from the observation range of the first image sensor device to a time taken for the second image sensor devices to control pan-tilt-zoom and observe the neighborhood takeover region, selecting an image sensor device with the shorter time.

9. The method of claim 1, further comprising:
when the intruder is not able to be tracked through cooperation with the second image sensor devices, assigning a task to track the intruder to a spare image sensor device.

10. A method of detecting an intruder based on a virtual fence, the method comprising:
detecting an object invading a virtual fence set in a protection area;
when the detected object is an intruder, tracking the intruder; and
controlling an observation range of an image sensor device by controlling pan-tilt-zoom (PTZ) of the image sensor device, in response to a command transmitted by a control center, and
wherein the virtual fence is dynamically set through cooperation with image sensor devices adjacent to the image sensor device by controlling PTZ of the image sensor device.

11. A device for monitoring an intruder based on a virtual fence, the device comprising:
a processor; and
a memory electrically connected to the processor and configured to store instructions executable by the processor,
wherein, when the instructions are executed by the processor, the processor is configured to perform a plurality of operations, and
wherein the plurality of operations comprises:
detecting an intruder invading a virtual fence set in a protection area by using a first image sensor device, and
tracking the intruder through cooperation with second image sensor devices adjacent to the first image sensor device, based on information of the intruder.

12. The device of claim 11, wherein the plurality of operations further comprises:
dynamically setting the virtual fence through cooperation with the second image sensor devices by controlling pan-tilt-zoom of the first image sensor device.

13. The device of claim 11, wherein the plurality of operations further comprises:
setting initial location information at which the intruder is detected by the first image sensor device to be an identifier to distinguish the intruder.

14. The device of claim 11, wherein the tracking comprises:
when the intruder escapes an observation range of the first image sensor device, selecting an image sensor device to track the intruder from among the second image sensor devices based on information of the intruder; and
assigning a task to track the intruder to a selected image sensor device.

15. The device of claim 14, wherein the tracking comprises calculating a neighborhood takeover region, which is a dead zone of the first image sensor device and occurs as the first image sensor device tracks the intruder.

16. The device of claim 15, wherein the neighborhood takeover region corresponds to a difference between an initial observation range of the first image sensor device and an updated observation range, which is updated based on tracking the intruder, of the first image sensor device.

17. The device of claim 15, wherein the tracking further comprises:
setting a range in which cooperation among the first image sensor device and the second image sensor devices is available based on a time taken for the intruder to escape from an observation range of an image sensor device and a time taken for the second image sensor devices to control pan-tilt-zoom (PTZ) and observe the neighborhood takeover region.

18. The device of claim 15, wherein the selecting comprises:
by comparing a time taken for the intruder to escape from the observation range of the first image sensor device to a time taken for the second image sensor devices to control pan-tilt-zoom (PTZ) and observe the neighborhood takeover region, selecting an image sensor device with the shorter time.

19. The device of claim 11, wherein the plurality of operations further comprises:
when the intruder is not able to be tracked through cooperation with the second image sensor devices, assigning a task to track the intruder to a spare image sensor device.
